(19) United States
(12) Patent Application Publication
(10) Pub. No.: US 2008/0277633 A1
(43) Pub. Date: Nov. 13, 2008

(54) Fire-Retardant/Intumescent Compositions

(75) Inventors: Lorraine Leite, Saint Marcel D'Ardeche (FR); Jean-Emile Zanetto, Paris (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, AUBERVILLIERS (FR)

(21) Appl. No.: 11/795,861

(22) PCT Filed: Jan. 23, 2006
(86) PCT No.: PCT/FR2006/000147

§ 371 Date: Apr. 14, 2008

(30) Foreign Application Priority Data
Jan. 24, 2005 (FR) 0500699

(51) Int. Cl. C09K 21/14; C09K 21/12

(52) U.S. Cl. 252/606; 523/179

(57) ABSTRACT

Fire-retardant and intumescent compositions, especially for fireproofing such plastics as polyolefins, e.g., polypropylenes and polyethylenes, and such copolymers as polyethylene vinyl acetate (EVA), contain at least one organophosphorus compound that has at least one carbon-phosphorus covalent bond and at least one carboxyl functional group, at least one swelling agent selected from among organic compounds containing at least one nitrogen atom and at least one silicon mineral structuring agent that is not decomposed during the combustion thereof, e.g., a silicate and/or a silicon oxide.

The present invention relates to a fire-retardant composition especially for fireproofing plastics such as polyolefins, like polypropylene and polyethylene, and also copolymers such as polyethylene vinyl acetate (EVA), for example.

It relates more particularly to a fire-retardant composition based on an organophosphorus compound and having an intumescent effect.

In many applications, it is necessary to modify the properties of plastics to enable them to be fire resistant. The term “fire resistance” is understood to mean a property that makes it possible to limit flame spread in order to avoid and minimize the formation of smoke or toxic gases.

It has been proposed to add to these plastics various additives known as fire retardants or flame retardants. For the plastics cited above, magnesium or aluminum hydroxides and also polybromodiphenyl ethers in combination with antimony oxide are the most used. For other thermoplastic polymers such as polyamides, compounds containing phosphorus or red phosphorus and also bromopolymers are often used.

For certain plastics such as polyolefins, the fire-retardant systems also comprise an additive that causes intumescence of the material under the effect of a flame. Such intumescent systems are characterized by the formation, at the time of combustion of the material, of a foam based on noncombustible carbon which slows the release of inflammable gases resulting from the combustion of the plastic such as a polyolefin.

These systems generally comprise several components of which the main ones are a swelling agent that produces nonflammable gases or vapors that help to form the carbon-based foam and a carbon- or char-generating agent, known in the technical field as a “char-forming agent”. Thus, the most used swelling agents are compounds of nitrogen such as urea, melamine and its derivatives and amine salts.

The char-forming agents are generally polyhydroxylated compounds such as sugars, trimethylolpropane, and mono- or polypentaerythritols.

A third component is used in combination with the swelling compounds, especially with the nitrogen-based compounds. This third component is a compound that generates acid at the time of combustion.

Such compounds are chosen from phosphorus-based compounds such as polyphosphates, organophosphites and organophosphates.

In some cases, especially when the plastic forms carbon itself during its combustion, the char-forming agent compound may be absent from the fireproofing or intumescent system.

Fire-retardant systems for thermoplastics comprising an acid organophosphorus compound and a swelling agent have already been proposed. Thus, patent EP 6568 describes a system comprising an organophosphonic acid or their salts combined with a melamine, dicyanamide or guanidine compound. This system is used to fireproof various plastics including polypropylene. However, such a system only allows a V2 classification to be obtained in the UL-94 test universally employed in the field of fireproofed plastics to characterize the resistance to flame spread or to combustion.

There is still a need to find a fire-retardant system that enables this classification to be improved in order, for example, to obtain a V0 classification.

One of the objects of the present invention is to provide a fire-retardant and intumescent system that can especially be used with polyolefins to obtain an improved classification of the fireproofed material according to the UL-94 test, relative to the known materials and also an increased limiting oxygen index (LOI) for combustion.

For this purpose, the invention provides a fire-retardant, intumescent composition for a plastic comprising at least one organophosphorus compound having at least one carbon-phosphorus covalent bond and at least one carboxyl functional group, at least one swelling agent chosen from the organic compounds containing at least one nitrogen atom and at least one mineral structuring agent that is not decomposed during combustion of the material. This mineral structuring agent is chosen from the group comprising silicon compounds such as silicates and oxides.

According to another feature of the invention, the organophosphorus compound corresponds to the general formulae I and II below:

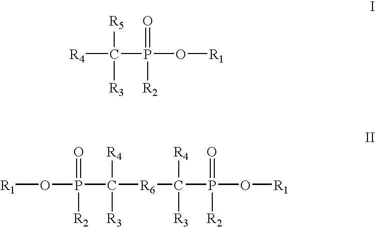

in which:
R₁ represents an alkyl group having from 1 to 6 carbon atoms or an aromatic group or hydrogen;
R₂ represents an OH group, an alkoxy group comprising from 1 to 6 carbon atoms or an alkyl group comprising from 1 to 6 carbon atoms;
R₃, R₄, R₅, which are identical or different, represent a hydrogen atom, an alkyl group comprising from 1 to 6 carbon atoms, a carboxyl group with a —COOR₆ group or a group of formula R₇—NH₂ in which R₇ represents an alkyl group comprising from 1 to 6 carbon atoms;
R₅ represents a covalent bond or a divalent alkyl radical comprising from 1 to 10 carbon atoms; and
R₆ represents an alkyl radical comprising from 1 to 6 carbon atoms.

According to one preferred feature of the invention, the organophosphorus compounds are chosen from the group comprising alkylphosphonic acids, aminoalkylphosphonic acids and carboxyalkylphosphonic acids.

In one preferred embodiment of the invention, the organophosphorus compounds are chosen from the group comprising carboxyethylphosphonic acid, (aminomethyl)phosphonic acid, or carboxymethylphosphonic acid.

According to the invention, the fire-retardant composition comprises at least one organic Compound containing at least one nitrogen atom. This compound is advantageously chosen from compounds belonging to the family of melamines, guanidines and/or dicyanamides.

Advantageously, melamine and its derivatives are preferred. Thus, mention may be made, by way of example, of melamine, melamine cyanurate, melamine phosphate, melamine diphosphate, melamine pyrophosphate, melem, melam and mixtures of these compounds. Particularly Preferably, melamine is used.

The composition of the invention also comprises a solid mineral structuring compound chosen, preferably, from the group of silicon oxides and more particularly from silicas.

As suitable silicas, mentioned may be made of the pyrogenic silicas, silica gels and the precipitated silicas.

the concentrations of these various compounds in the fire-retardant composition are not critical and may vary in large proportions.

The preferred concentration ranges of these various compounds, expressed in wt % relative to the weight of the fire-retardant composition or of all the components forming the fire-retardant system, are given below:
organophosphorus compound: 60-85%
compound with nitrogen atom (melamine): 10-25%
mineral structuring agent: 1-15%

In one particular embodiment of the invention, the fire-retardant composition may comprise a char-forming agent, as indicated previously. This compound is preferably chosen from the group comprising polyhydroxylated alcohols, carbohydrates, sugars, starches, of formula (C₆H₁₀O₅)m, polyethylene glycol and polyhydroxylated polymers.

Even more preferably, the char-forming agent is chosen from the group comprising mono-, di- and triperitaerythritol, ethylene glycol, propylene glycol and ethylene/vinyl alcohol copolymers.

Such a compound is present in the fire-retardant composition at a weight concentration of 1 to 35% relative to the weight of the fire-retardant composition.

These compounds may be mixed prior to their addition to a polymer material to be fireproofed. However, without departing from the scope of the invention, these various compounds may be added separately or in combination with one or more other compounds to the polymer material.

Another subject of the invention consists of a fireproofed material comprising a matrix made of a plastic and a fire-retardant system composed of a fire-retardant and intumescent composition as described above mixed directly with the matrix or obtained by addition of its various components to the matrix.

As plastic forming the matrix of the material, the invention more particularly applies to polyolefins such as polypropylenes and polyethylenes and to copolymers such as polyethylene vinyl acetate.

The weight concentration of fire-retardant composition in the fireproofed material is advantageously between 10 and 40%, preferably 20 and 35%, relative to the total weight of the composition.

Thus, the weight concentrations of the various compounds forming the fire-retardant system in the fireproofed material are advantageously contained in the following ranges:
10% to 30% for the organophosphorus compound;
1% to 10% for the nitrogen-containing compound; and
0.1% to 5% for the silicon oxide compound.

The fireproofed material of the invention may comprise other additives such as reinforcing fillers, bulking fillers, dyes, pigments, additives giving oxidation stability, and additives that improve the resistance properties of the material relative to heat, moisture, light and/or UV radiation.

It may also comprise additives for improving the processability of the material such as mold release additives and lubricants, for example.

The materials of the invention are especially used for manufacturing articles by various forming processes such as, for example, injection molding, extrusion, pultrusion, injection-blow molding or similar processes.

The materials according to the invention are manufactured according to conventional processes for manufacturing a composition based on a filled plastic. Thus, the fire-retardant composition may be added to the molten polymer, the mixing being advantageously carried out in a device comprising one or more feed screws. In this process, the fire-retardant composition may be added as it is or in the form of a concentrated solution or “masterbatch”. It may also be added by separate addition of the various compounds to the molten polyolefin.

The material to which such additions have thus been made is advantageously formed in an extruder or any other means for forming granules of cylindrical or spherical shape, known as molding powder. These granules are fed into the processes for manufacturing articles after optional drying or any other treatment known to a person skilled in the art.

The fireproofing properties of these materials are illustrated by various measurements. One of the most common is the test known as UL 94 which, briefly, for test pieces of various thicknesses, consists in determining the self-extinguishing time of a flame. This test is standardized under the reference ISO 1210:1992 (F)

It is also advantageous to determine the limiting oxygen index (LOI) required to maintain the flame. This index is determined according to the ISO 4589-2 standard.

Other advantages and details of the invention will appear more clearly in view of the examples given solely by way of illustration, without being limiting.

In the examples and formulations given below, the 2-carboxyethylphosphonic acid and the types of silica mentioned are sold by Rhodia, and the melamine is sold by DSM. The aluminum hydroxide is sold by Albermarle under the reference Martifin OL 107.

The polypropylene is a PPH6040 grade sold by Total, as is the polyethylene vinyl acetate (Evatane 1020). The high-density polyethylene is sold by Sabic.

### EXAMPLE 1

### Fire-Retardant Composition A

The intumescent or fire-retardant composition A comprised 80 wt % of 2-carboxyethylphosphonic acid as an acid source, and 20 wt % of 2,4,6-triamino-1,3,5-triazine (melamine) as a swelling agent. These components were closely mixed in a rapid mixer having blender type blades in order to obtain a powder.

### EXAMPLE 2

### Fire-Retardant Composition B

The intumescent or fire-retardant composition B comprised respectively 73 wt % of 2-carboxyethylphosphonic acid as an acid source and char-forming agent, 18 wt % of 2,4,6-triamino-1,3,5-triazine (melamine) as a swelling agent and 9 wt % of silica as a structuring agent. These components were closely mixed using a rapid mixer having blender type blades in order to obtain a powder.

### EXAMPLES 3 TO 5

Three compositions were prepared according to the following procedures.

### Composition C (Comparative)

The polypropylene alone was compounded for 3 minutes at 200 rpm in a 300 cm³ Haake internal mixer heated at 155° C., and the compounding was continued for 3 minutes after melting, without addition of additive.

### Composition C1 (Comparative)

The polypropylene alone was compounded for 3 minutes at 200 rpm in a 300 cm³ Haake internal mixer heated at 155° C.
The 2-carboxyethylphosphonic acid and the melamine were introduced successively into the mixer, in the proportions making it possible to obtain an overall fraction of the fire-retardant system, relative to the total weight of the mixture, equal to 30 wt %, i.e. 24 wt % 2-carboxyethylphosphonic acid and 6 wt % melamine. After this incorporation, the compounding was continued for 3 minutes.

### Composition C2

The polypropylene alone was compounded for 3 minutes at 200 rpm at 155° C. The 2-carboxyethylphosphonic acid, the melamine and a silica sold under the name TIXOSIL 38X by Rhodia were introduced successively into the mixer, in the proportions making it possible to obtain an overall fraction of the fire-retardant system, relative to the total weight of the mixture, equal to 33 wt %, i.e. 24 wt % of 2-carboxyethylphosphonic acid, 6 wt % of melamine and 3 wt % of silica T38X. After this incorporation, the compounding was continued for 3 minutes.

Next, the three compositions obtained were compression molded with a suitable mold in a Schwabenthan platen press, at a temperature of 190° C., under a pressure of 1 bar for 4 minutes, then 100 bar for 1 minute and 200 bar for 1 minute; next it was cooled for 4 minutes while maintaining this pressure of 200 bar.

Thus, by compression molding, bars (thickness 1.6 mm) for the UL94V type of fire behavior tests and bars for the LOI test described below were obtained.

The fire behavior of the samples obtained was tested by following:

the UL-94 test according to the procedure of the “Underwriters Laboratories” described in the standard ISO 1210:1992 (F). This test was carried out, depending on the case, with test pieces having thicknesses of 6.4, 3.2, 1.6, 0.8 and 0.4 mm; and

the limiting oxygen index LOI, according to the procedure described in the standard ISO 4589-2, represents the minimum volume concentration of oxygen, in an oxygen/nitrogen mixture, necessary to maintain the combustion of a test piece. The higher this value, the better the protection against combustion.

These tests were carried out on the above polypropylene samples C, C1 and C2, formed in order to obtain test pieces having thicknesses of 1.6 mm for the UL94 tests and having a thickness of 4 mm for the LOI measurement.

The results of these tests are given in Table I below following the classification criteria defined by the previously mentioned standards.

TABLE I

| Compositions | LOI (%) | UL94V Classification (1.6 mm) |
|---|---|---|
| C | 18 | NC (not classified) |
| C1 | 34 | V2 |
| C2 | 38.5 | V0 |

These tests show that the formulation obtained according to Example C2 gives the polypropylene very good fire-retardant properties. Indeed, a UL94 classification of V0 as obtained for a thickness of 1.6 mm and the limiting oxygen index changed from 18% for polypropylene without any additive to 38.5% for the fireproofed material according to the invention.

### EXAMPLES 6 TO 11

### Composition D (Comparative)

An 80/20 mixture by weight of HDPE/EVA (high-density polyethylene/ethylene/vinyl acetate copolymer) was compounded at 200 rpm in a 300 cm³ Haake internal mixer heated at 155° C., until the polymers melted, and the compounding was continued for 3 minutes after melting, without addition of additive.

### Composition D1 (Comparative)

The 80/20 mixture by weight of HDPE/EVA identical to composition D was compounded at 200 rpm in a 300 cm³ Haake internal mixer heated at 155° C., until the polymers melted. Next, 61 wt % of aluminum hydroxide, a flame-retardant additive commonly used in polyolefins, was added to the mixer. The compounding was continued for 3 minutes after this incorporation.

### Composition D2 (Comparative)

The 80/20 mixture by weight of HDPE/EVA identical to the composition D was compounded at 200 rpm in a 300 cm³ Haake internal mixer heated at 155° C., until the polymers melted. The formulated powder A from Example 1 was introduced into the mixer. The overall fraction of fire retardant relative to the total weight of the mixture was equal to 30 wt %, i.e. 24 wt % of 2-carboxyethylphosphonic acid and 6 wt % of melamine. After this incorporation, the compounding was continued for 3 minutes.

### Composition D3

The 80/20 weight mixture of HDPE/EVA identical to Example D was compounded at 200 rpm in a 300 cm³ Haake internal mixer heated at 155° C., until the polymers melted. The formulated powder from Example 2 obtained with, as a silica, a silica sold by Rhodia under the name TIXOSIL 38X was introduced into the mixer. The overall fraction of fire retardant relative to the total weight of the mixture was equal to 33 wt %, i.e. 24 wt % of 2-carboxyethylphosphonic acid, 6 wt % of melamine and 3 wt % of silica T38X. After this incorporation, the compounding was continued for 3 minutes.

### Composition D4

The 80/20 weight mixture of HDPE/EVA identical to the Example D was compounded at 200 rpm in a 300 cm³ Haake internal mixer heated at 155° C., until the polymers melted. A formulated powder, according to Example 2, obtained with a silica sold by Rhodia under the name SILOA 72X was introduced into the mixer. The overall fraction of fire retardant relative to the total weight of the mixture was equal to 33 wt %, i.e. 24 wt % of 2-carboxyethylphosphonic acid, 6 wt % of melamine and 3 wt % of silica SILOA 72X. After this incorporation, the compounding was continued for 3 minutes.

Next, the above compositions were compression molded in a Schwabenthan platen press, at a temperature of 190° C., under a pressure of 1 bar for 4 minutes, then 100 bar for 1 minute and 200 bar for 1 minute; next it was cooled for 4 minutes while maintaining this pressure of 200 bar.

Thus, by compression molding, test pieces (thickness 1.6 mm) were obtained that conform to and were suitable for the implementation of the UL94V type fire behavior tests for determining the LOI.

The fire behavior properties of these compositions were determined according to the tests and procedures described previously.

The results obtained are given in Table II below.

| | | UL94V Classification |
|---|---|---|
| Composition | LOI (%) | (1.6 mm) |
| D | 18.5 | NC (not classified) |
| D1 | 30.5 | NC |
| D2 | 29.5 | V2 |
| D3 | 33.5 | V2 |
| D4 | 37 | V2 |

1.-14. (canceled)

15. A fire-retardant and intumescent composition for plastics which comprises at least one organophosphorus compound containing at least one phosphorus-carbon covalent bond and at least one acid functional group bonded to the phosphorus atom, at least one compound containing at least one nitrogen atom selected from the group consisting of melamine and derivatives thereof, guanidine, a cyanamide, and mixtures thereof, and at least one mineral silicon structuring compound.

16. The fire-retardant and intumescent composition as defined by claim 15, comprising a char-forming compound.

17. The fire-retardant and intumescent composition as defined by claim 15, wherein the organophosphorus compound is selected from among the compounds having the general formulae (I) and (II) below: 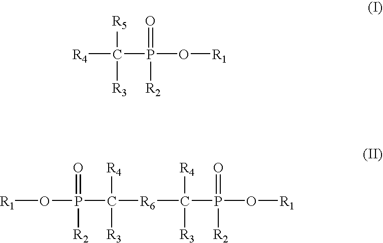
in which:
R₁ is an alkyl radical having from 1 to 6 carbon atoms or an aromatic radical or a hydrogen atom;
R₂ is an OH group, an alkoxy radical having from 1 to 6 carbon atoms or an alkyl radical having from 1 to 6 carbon atoms;
R₃, R₄, R₅, which may be identical or different, are each a hydrogen atom, an alkyl radical having from 1 to 6 carbon atoms, a carboxyl group with a —COOR₆ group or a group of formula R₇—NH₂ in which R₇ is an alkyl radical having from 1 to 6 carbon atoms;
R₅ is a covalent bond or a divalent alkyl radical having from 1 to 10 carbon atoms; and
R₆ is an alkyl radical having from 1 to 6 carbon atoms.

18. The fire-retardant and intumescent composition as defined by claim 17, wherein the organophosphorus compound comprises an alkylphosphonic acid, aminoalkylphosphonic acid or a carboxyalkylphosphonic acid.

19. The fire-retardant and intumescent composition as defined by claim 18, wherein the organophosphorus compound comprises a carboxyethylphosphonic acid, (aminomethyl)phosphonic acid, or carboxymethylphosphonic acid.

20. The fire-retardant and intumescent composition as defined by claim 15, wherein the compound comprising a nitrogen atom is selected from the group consisting of melamine, melamine cyanurate, melamine phosphate, melamine diphosphate, melamine pyrophosphate, melem, and mixtures thereof.

21. The fire-retardant and intumescent composition as defined by claim 15, wherein the at least one silicon compound comprises a silica or a silicate.

22. The fire-retardant and intumescent composition as defined by claim 15, comprising, by weight:
organophosphorus compound: 60-85%
compound with nitrogen atom: 10-25%
mineral structuring agent: 1-15%.

23. The fire-retardant and intumescent composition as defined by claim 16, wherein the char-forming compound is selected from the group consisting of a polyhydroxylated alcohol, carbohydrate, sugar, starch, of formula (C₆H₁₀O₅)m, polyethylene glycol and polyhydroxylated polymer.

24. The fire-retardant and intumescent composition as defined by claim 23, wherein the char-forming agent is selected from the group consisting of mono-, di- and tripentaerythritol, ethylene glycol, propylene glycol and an ethylene/vinyl alcohol copolymer.

25. A fireproofed material comprising a matrix shaped from a plastic and a fire-retardant or intumescent composition as defined by claim 15.

26. The fireproof material as defined by claim 25, wherein the plastic comprises a polyolefin or an ethylene/vinyl acetate copolymer.

27. The fireproof material as defined by claim 26, comprising a polypropylene or a polyethylene.

28. The fireproof material as defined by claim 25, further comprising a filler and/or additive.
